(19) United States
(12) Patent Application Publication
(10) Pub. No.: US 2026/0266082 A1
(43) Pub. Date: Sep. 10, 2026

(54) SUSTAINABLE DWELLING SYSTEM

(71) Applicant: K2 Construction LLC, Fredericksburg, VA (US)

(72) Inventor: Ibrahim Aziz Yussuf, Fredericksburg, VA (US)

(73) Assignee: K2 Construction LLC, Fredericksburg, VA (US)

(21) Appl. No.: 19/073,857

(22) Filed: Mar. 7, 2025

(51) Int. Cl. E04H 9/08; E03B 3/03; E03B 3/28; E06B 7/23; F24F 8/10; F41H 3/00; F41H 5/24; G07C 9/25; H04N 7/18

(52) U.S. Cl. CPC E04H 9/08; E03B 3/03; E03B 3/28; E06B 7/23; F24F 8/10; F41H 3/00; F41H 5/24; G07C 9/257; H04N 7/18

(57) ABSTRACT

A self-sustainable, turn-key dwelling system includes a security network, transportation network, medical network, energy management network, automation network, waste management network, tooling workshop network, air management network, surveillance network, resource management network, outer self-sustainable dwelling system structures, and indoor self-sustainable dwelling system structures. The indoor self-sustainable dwelling system structures include above-ground indoor self-sustainable dwelling system structures and an underground bunker network. The above-ground structures are integrated with the underground bunker network. The dwelling system supports independent living for up to one year during catastrophic events and disasters.

### CROSS-REFERENCE TO RELATED APPLICATIONS

This original Nonprovisional Application does not claim benefit to any prior applications.

### FEDERALLY SPONSORED RESEARCH AND DEVELOPMENT

Not applicable.

The present disclosure relates to an apparatus, method, and system for a sustainable dwelling and living and dwelling system, particularly during a catastrophic event and doomsday scenario, and also provides a comprehensive protection system.

### BACKGROUND OF THE INVENTION

The United States of America and the world are currently facing numerous threats that span environmental, geopolitical, technological, and public health domains. These threats, unprecedented in their complexity, underscore the urgent need for innovative solutions, collective action, and strategic foresight.

The disclosure herein provides a comprehensive security system for a dwelling system during a catastrophic event.

### SUMMARY OF THE INVENTION

This application relates to an apparatus, system, and method for a complete turn-key residential and dwelling system and structure/s, which may be a self-sustainable dwelling and living and dwelling system for non-civilians or/and civilians with integrated protection systems. The self-sustainable dwelling system includes, but is not limited to, a security network, a transportation network, a medical network, an energy management network, an automation network, a waste management network, a tooling work-shop network, an air management network, a surveillance network, and a resource management network. The dwelling system may be integrated with at least one bunker network with above-ground structures, and the system may be configured for up to one year of independent dwelling during disaster/s.

The disclosure herein relates to a self-sustainable turn-key dwelling system made of a security network, a transportation network, a medical network, an energy management network, an automation network, a waste management network, a tooling work-shop network, an air management network, a surveillance network, a resource management network, outer-self-sustainable dwelling and living system structures, and indoor-self-sustainable dwelling and living system structures.

The disclosure herein relates to an indoor-self-sustainable living and dwelling system structure that is further made of an above-ground indoor-self-sustainable living and dwelling system structure and underground bunker network. The above-ground indoor-self-sustainable living and dwelling system structures are integrated with the underground bunker network.

This self-sustainable living and dwelling system may be used during short-term or long-term disasters such as natural disasters, civil unrest, nuclear war, pandemics, etc. This sustainable living and dwelling system integrates bunker-style building structures with residential-style building structures, one or more outposts and/or towers, and transportation systems.

This residential dwelling system may provide self-sustainability and complete security during short-term stays, long-term living and dwelling, or both. The self-sustainable dwelling system may ensure the comforts of modern living and dwelling and provide safety during and after short- or long-term disasters.

In some aspects, the techniques described herein relate to the dwelling system with a surveillance network that may include at least one drone and at least one outdoor camera.

In some aspects, the techniques described herein relate to the dwelling system's transport network that may include at least one vehicle and fuel required to transport individual/s to and from another secure location, wherein the vehicle is bulletproof.

In some aspects, the techniques described herein relate to the dwelling system, which may include indoor dwelling space and outdoor dwelling space, wherein the indoor space may be up to 5,000 square feet and the outdoor dwelling space may be up to 10,000 square feet.

In some aspects, the techniques described herein relate to the dwelling system's resource management network, which may include a rain catcher framework. The rain catcher framework may be interconnected/interlinked to gutters and configured to catch rain into a water storage unit, wherein the water storage unit capacity may be up to 1000 gallons.

In some aspects, the techniques described herein relate to the dwelling system's resource management network, which may include a food supply infrastructure comprising long-term food storage and food renewal modules (e.g., hydroponics, aquaponics, vertical farming). The food supply infrastructure, encompassing long-term food storage and food renewal modules (e.g., hydroponics, aquaponics, vertical farming), may include at least one food-storage unit/s adapted to store food for up to 50 years.

In some aspects, the techniques described herein relate to the food supply infrastructure, including long-term food storage and food renewal modules (e.g., hydroponics, aquaponics, vertical farming), which may include at least one food renewal module/s, which may be further configured to grow food on premises.

In some aspects, the techniques described herein relate to a security network, which may include at least one nuclear containment unit/s, wherein the unit/s is indoors.

In some aspects of the techniques described herein, the security network comprises at least one nuclear containment unit, for example, 1, 2, 3, 4, 5, 6, 7, 8, 9, 10, 11, 12, 13, 14, 15, 16, 17, 18, 19, 20, 21, 22, 23, 24, 25, and any combination thereof.

In some aspects of the techniques described herein, the containment unit is indoor air-tight and/or sealed.

In some aspects, the techniques described herein relate to a security network that may include an indoor dwelling bunker-style building structure integrated with residential-style building structures and at least one outdoor outpost and/or tower. The bunker-style building structure may be reinforced with concrete and steel, wherein the bunker-style building structure may be at least three feet below the ground surface.

In some aspects, the techniques described herein relate to a security network may include at least one electronic equipment security subnetwork configured to block electromagnetic pulse/radiation from entering indoor dwelling space, and wherein the blocking may be configured via one or more selected from a group consisting of Faraday cage, EMI Shielding (Electromagnetic Interference Shielding), Mu-Metal Shielding, Conductive Enclosures, Shielded Rooms, RF Shielding, Gasket Seals, and any combination thereof.

In some aspects, the techniques described herein relate to the security network that may include armored-resistant and armored-proof materials selected from one or more from a group consisting of fiberglass, synthetic fiber, Kevlar, Dyneema, ultra-high-molecular-weight polyethylene (UHMWPE), Ceramic, alumina and silicon carbide, Steel, Carbon Nanotubes, Titanium, Aluminum Oxide, Polycarbonate, Composite Armor, a combination of ceramics, metals, and fibers, Graphene, and any combination thereof.

In some aspects, the techniques described herein relate to a security network that may include window-coverings and doors-coverings, wherein the coverings have at least one Gear Consoles, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, etc., and shelves with gun holders configured to organize the coverings.

In some aspects, the techniques described herein relate to a security network that may include window coverings and door-coverings, wherein the coverings have at least one Gear Consoles and shelves with gun holders configured to organize the coverings. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, Gear Consoles, and any combination thereof.

In some aspects, the techniques described herein relate to a security network that may include roof overhangs and window drip edge/s configured to protect the dwelling from rainwater and may or may not be linked to the rain catchers.

In some aspects, the techniques described herein relate to a security network that may independently or jointly with an energy management network form and include a closed-cell foam-insulated ceiling, acoustic foam-covered walls, and a high-density foam pad underneath a marine-carpeted floor configured to provide insulation and sound security.

In some aspects, the techniques described herein relate to an air management network that may include at least one air seal/s, air suction ventilator/s, and/or air filter/s, wherein the air seal/s may be adapted to seal indoor dwelling from outdoor dwelling air and may prevent outdoor air from entering indoor and indoor air from escaping to outdoor. The sealing may be up to 99%, and the air suction ventilators may be connected to air filters, wherein the air filters may be selected from a group consisting of biological filters, chemical filters, nuclear filters, and any combination thereof.

In some aspects, the techniques described herein relate to a security network that may include windows and doors with high-quality automotive window gaskets and door molding adapted to seal the window/s and door/s from an exchange of air between indoor and outdoor air.

In some aspects, the techniques described herein relate to an energy management network that may include an energy-generating subnetwork, wherein the energy-generating network may be installed within 18 inches (457 mm) of the indoor dwelling. 19.

In some aspects, the techniques described herein relate to indoor-self-sustainable living and dwelling system structures with up to 10 inches of structural channel reinforcements.

In some aspects, the techniques described herein relate to indoor-self-sustainable living and dwelling system structures that may be surrounded by a steel wall up to 0.5 inches thick.

In some aspects, the techniques described herein relate to indoor-self-sustainable living and dwelling system structures that may be up to 15-inch reinforced concrete walls.

In some aspects, the techniques described herein relate to the outer-self-sustainable dwelling system structures, which are dynamic camouflage structures. These structures incorporate photochromic and electrochromic coatings that adjust color, reflectivity, and thermal signature to blend into surrounding environments.

In some aspects, the techniques described herein relate to modular, AI-enhanced disaster-resistant dwelling systems including a biometrically adaptive access control system, motorized, robotic partitions and furniture system, a high-resilience underground bunker network, nuclear, biological, and chemical (NBC) air filtration systems, an AI-guided transportation network, a drone-based cargo and supply delivery system, capable of autonomously restocking food, medical supplies, and energy reserves,

In some aspects, the techniques described herein relate to the biometrically adaptive access control system utilizing multi-factor authentication and configured to analyze and regulate entry permissions to designated zones, a reconfigurable smart interior,

In some aspects, the techniques described herein relate to the motorized partition and furniture system is adapted to occupant needs for emergency lockdown, expanded communal spaces, or isolated medical zones,

In some aspects, the techniques described herein relate to underground bunker networks incorporate blast-resistant reinforced concrete and carbon-nanotube-reinforced steel alloys for impact protection,

In some aspects, the techniques described herein relate to AI-guided transportation, including at least one armored bug-out vehicle with integrated fuel storage, remote AI navigation, and autonomous security measures deployed for emergency evacuation or resupply missions network.

In some aspects, the techniques described herein relate to a self-sustaining dwelling system, including an artificial intelligence (AI)-powered resource management system configured to autonomously optimize energy consumption, water usage, waste processing, and climate control in real-time based on occupant activity and environmental conditions, and an integrated underground bunker equipped with an AI-calibrated climate control system to maintain optimal living conditions.

In some aspects, the techniques described herein relate to the self-healing structural material layer, utilizing biopolymer-infused concrete or nanocomposite materials to repair cracks and fractures automatically, including biopolymer-infused concrete or nanocomposite materials capable of autonomously repairing cracks, fractures, or environmental damage.

In some aspects, the techniques described herein relate to an autonomous drone-based surveillance system utilizing facial recognition, LiDAR scanning, and AI-driven threat detection.

In some aspects, the techniques described herein relate to an EMP-shielded infrastructure utilizing a multi-layered Faraday cage enclosure to protect electronic components from electromagnetic interference or attacks.

In some aspects, the techniques described herein relate to a blockchain-encrypted cybersecurity system securing all digital communication and access controls within the dwelling.

In some aspects, the techniques described herein relate to the self-sustaining dwelling system, including a dynamic camouflage system, incorporating photochromic and electrochromic coatings that adjust color, reflectivity, and thermal signature autonomously, a defense and security network, a renewable energy harvesting network, a kinetic energy harvesting flooring system, a sustainable water generation and purification system, an AI-managed waste conversion system.

In some aspects, the techniques described herein relate to the dynamic camouflage system, incorporating photochromic and electrochromic coatings that adjust color, reflectivity, and thermal signature autonomously, including the outer walls of the dwelling structure with photochromic and electrochromic coatings configured to adjust color, reflectivity, and thermal signature to blend into surrounding environments.

In some aspects, the techniques described herein relate to the dynamic and security system, including autonomous robotic perimeter surveillance units configured to deploy kinetic response barriers and non-lethal deterrent measures in response to unauthorized intrusions.

In some aspects, the techniques described herein relate to the renewable energy harvesting network, which includes a quantum-dot photovoltaic panel array configured to convert solar energy with high efficiency while serving as a protective outer dwelling shell.

In some aspects, the techniques described herein relate to the energy-storing concrete infrastructure, including thermal batteries that store and release energy incorporated into walls and floors.

In some aspects, the techniques described herein relate to the kinetic energy harvesting flooring system include piezoelectric materials configured to generate electrical power from occupant movement.

In some aspects, the techniques described herein relate to sustainable water generation and purification systems. These include atmospheric water harvesting technology utilizing graphene-based filtration membranes to extract and purify moisture from ambient air.

In some aspects, the techniques described herein relate to the AI-controlled water recycling and distribution network dynamically adjusting water supply for sanitation, irrigation, and drinking purposes.

In some aspects, the techniques described herein relate to the AI-managed waste conversion system. Organic waste is processed using a microbial bioreactor to produce renewable biofuel and soil-enriching compost for on-premises agriculture.

### BRIEF DESCRIPTION OF DRAWINGS

FIG. 1. This depicts a cross-sectional view of an underground shelter or survival bunker network.

FIG. 2. This shows a top-down layout plan of an underground shelter or survival bunker.

FIG. 3. This is a detailed schematic layout of an underground survival shelter labeled with various functional areas and security features.

FIG. 4. This is a flowchart depicting the layout of an example of a “self-sustainable turn-key dwelling” designed for self-sufficiency, security, and survival.

FIG. 5. This flowchart represents the layout of a “primary residence,” a hardened structure” that integrates security, survival, and functional components.

FIG. 6. This is a flowchart representing an underground “Bunker Network” layout with elements or components of the network.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of the embodiments of the present disclosure. It will be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

As used herein, the term “security network” means comprehensive security during catastrophic event/s such as natural disasters, natural disasters, health crises, environmental catastrophes, geopolitical events, and cyber disasters, such as but not limited to earthquakes, hurricanes/cyclones/typhoons, tornadoes, floods, wildfires, pandemics, epidemics, industrial accidents, transportation accidents, explosions and fires, droughts, famine, environmental degradation, war and armed conflict, terrorist attacks, cyberattacks, and any combination thereof.

As used herein, the term “transportation network” means secure transportation of people and assets during catastrophic event/s within and/or to and from the self-sustainable dwelling system.

As used herein, the term “resource management network” means managing critical resources during catastrophic event/s, resources such as, but not limited to, food, water, emergency supplies, and any combination thereof.

As used herein, the term “medical network” means a medication/s, medical equipment/s, medical instruments, medical room/s, building/s, vehicle/s, and any combination thereof for medical intervention during a catastrophic event/s.

As used herein, the term “an energy management network” means resources that provide energy during a catastrophic event/s.

As used herein, the term “tooling work-shop network” means a workshop for making and/or repairing tools and equipment during a catastrophic event/s.

As used herein, the term “air management network” means resources required to provide clean and/or breathable air during a catastrophic event/s.

As used herein, the term “surveillance network” means any equipment, structure/s, transportation aerial and ground units, etc., and any combination thereof for providing surveillance during a catastrophic event/s.

As used herein, the term “automation network” means any communication and control wirelessly and/or directly of equipment/s, instrument/s, building/s, structure/s, part/s thereof, and any combination thereof during catastrophic event/s.

As used herein, the term “waste management network” means storage and/or converting any household waste, hazardous waste, medical waste, recyclable waste, sanitation waste, water waste, etc., and/or any combination thereof during catastrophic event/s.

As used herein, the term “bunker network” means any structure/s and building/s underground.

As used herein, the term “outer-self-sustainable living and dwelling system structures” means any structure, equipment, dwelling spaces, etc., outside the central living and dwelling space/structure/building of the self-sustainable dwelling system.

As used herein, the term “indoor-self-sustainable living and dwelling system structures” means any indoor living and dwelling space/structure/building/equipment of the self-sustainable dwelling system. Often referred to herein as indoor dwelling space, it includes above-ground and/or underground spaces and structures.

As used herein, the term “dynamic camouflage system” means an adaptive interior and/or exterior technology that utilizes photochromic and electrochromic coatings to alter the dwelling's and/or part thereof color, reflectivity, and thermal signature in response to environmental conditions, enhancing concealment, reducing detectability, AI, and/or automatically regulated

As used herein, the term “self-healing structural material layer” means a biopolymer-infused concrete or nanocomposite-based system designed to autonomously repair cracks, fractures, and minor structural damage using embedded microcapsules, self-sealing polymers, or bacteria-based mineralization.

As used herein, the term “AI-powered resource management system” means optimizes energy, water, waste, and climate control, etc., in an autonomous intelligence network that optimizes all aspects of the indoor, outdoor, above, and/or underground dwelling, such as, but not limited to, energy management network and energy use, water management, a waste management network and waste processing, security network, climate control, transportation network, medical network, automation network, tooling work-shop network, an air management network, a surveillance network, a resource management network, etc., and/or any combination thereof by dynamically adjusting resources based on real-time near-real-time, short, long-term data (and/or any combination thereof) and predictive analytics.

All systems, networks, modules, units, etc., detailed herein have their respective structures, functions, and methods of use and manufacture, which may be interlinked and/or overlap as needed to achieve the objectives of the current disclosure.

The disclosure relates to an apparatus, system, and method for a complete turn-key residential and dwelling system and structure/s, which may be a self-sustainable dwelling and living and dwelling system for non-civilians and/or civilians with integrated protection systems. The self-sustainable dwelling system includes, but is not limited to, a security network, a transportation network, a resource management network, a medical network, an energy management network, a tooling work-shop network, an air management network, a surveillance network, an automation network, and a waste management network.

The disclosure herein relates to a complete turn-key residential structure, a self-sustainable dwelling and living and dwelling system for non-civilians and/or civilians with integrated protection systems. This sustainable dwelling system may be used during short-term or long-term disasters such as natural disasters, civil unrest, nuclear war, pandemics, etc. This sustainable living and dwelling system integrates bunker-style building structures with residential-style building structures, one or more outposts, and/or towers (for example, 1, 2, 3, 4, 5, 6, 7, 8, 9, 10, 11, 12, 13, 14, 15, 16, 17, 18, 19, 20, etc.). The dwelling and residential system may provide self-sustainability and complete security during short-term stays (for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 days), long-term living and dwelling, or both. The self-sustainable system may ensure the comforts of modern living and dwelling and provide safety during and after short- or long-term disasters.

The disclosure herein relates to a self-sustainable turn-key dwelling system made of a security network, a transportation network, a medical network, an energy management network, an automation network, a waste management network, a tooling work-shop network, an air management network, a surveillance network, a resource management network, outer-self-sustainable living and dwelling system structures, and indoor-self-sustainable living and dwelling system structures.

The disclosure herein relates to an indoor-self-sustainable living and dwelling system structure that is further made of an above-ground indoor-self-sustainable living and dwelling system structure and underground bunker network. The above-ground indoor-self-sustainable living and dwelling system structures are integrated with the underground bunker network.

Furthermore, by incorporating self-healing materials, AI-coordinated disaster resilience, EMP protection, energy-harvesting infrastructure, and automated defense networks, this advanced system surpasses existing survival-oriented housing solutions, offering unparalleled autonomy, sustainability, and protection in disaster scenarios.

Furthermore, integrating quantum-dot solar energy, kinetic energy harvesting, AI-managed agriculture, and blockchain-based security establishes a new benchmark for long-term disaster resilience, offering a non-obvious improvement over prior art in sustainable living solutions.

The dwelling system may be integrated with at least one bunker network, and the bunker network may be made up of at least one or more bunker units (for example, 1, 2, 3, 4, 5, 6, 7, 8, 09, 10, etc.) with above-ground structures. One bunker unit may be equivalent to one room or open space without a permanent dividing wall/s.

The dwelling system may offer protection against natural disasters such as earthquakes, tornadoes, hurricanes, floods, etc., or any combination thereof. Additionally, sustainable dwelling systems may protect occupants from radiation and nuclear fallout in the event of a nuclear explosion.

In some aspects of the techniques described herein, the self-sustainable dwelling system may have an underground reinforced concrete bunker unit/s, steel bunker, or both.

The dwelling system may be configured for up to one year of independent dwelling during disaster/s; for example, 0.25, 0.5, 1, 2, 3, 4, 5, 6, 7, 8, 9, 10, 11 months.

This sustainable living and dwelling system integrates bunker-style building structures with residential-style building structures, one or more outposts and/or towers, and transportation systems.

This residential dwelling system may provide self-sustainability and complete security during short-term stays, long-term living and dwelling, or both. The self-sustainable dwelling system may ensure the comforts of modern living and dwelling and provide safety during and after short- or long-term disasters.

In some aspects, the techniques described herein relate to indoor-self-sustainable living and dwelling system structures with up to 10 inches of structural channel reinforcements. For example, up to 0.5, 1. 1.5, 2, 2.5, 3.5, 4, 4.5, 5, 5.5, 6, 6.5, 7, 7.5, 8, 9, 9.5, 10 inches and any combination thereof of structural channel reinforcements.

In some aspects, the techniques described herein relate to indoor-self-sustainable living and dwelling system structures that may be surrounded by a steel wall up to 0.5 inches thick, for example, 0.1, 0.15, 0.2, 0.25, 0.3, 0.35, 0.4, 0.45, 0.5 inches and any combination thereof.

In some aspects, the techniques described herein relate to indoor-self-sustainable living and dwelling system structures that may be up to 15-inch reinforced concrete walls, for example, 1, 2, 3, 4, 5, 6, 7, 8, 9, 10, 11, 12, 13, 14, 15 inches, and any combination thereof.

In some aspects of the techniques described herein, the dwelling systems may be designed to withstand blasts from bombs, missiles, and other explosive such as nuclear and/or non-nuclear devices. One or more walls and/or roofs may be reinforced to absorb; one or more walls and/or roofs may be designed to deflect explosion force.

In some aspects of the techniques described herein, the sustainable dwelling and living and dwelling system may provide for a short-term stay of a few hours to a few days or weeks, for example, 1, 2, 3, 4, 5, 6, 7, 8, 9, 10, 11, 12, 13, 14, 15, 16, 17, 18, 19, 20, 21, 22, 23, 24, 25 hours, and/or any combination thereof. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 days, and/or any combination thereof. For example, 1, 2, 3, 4, 5, 6, 7, 8, 9, 10, 12 weeks and/or any combination thereof.

In some aspects of the techniques described herein, the sustainable dwelling system may provide for a long-term stay of a few weeks to a few months or years, for example, 1, 2, 3, 4, 5, 6, 7, 8, 9, 10, 12, months, and/or any combination thereof. For example, 1, 2, 3, 4, 5, 6, 7, 8, 9, 10, 12 years, and/or any combination thereof.

In some aspects of the techniques described herein, the sustainable dwelling system may range from 200 square feet to 10,000 square feet with, without a deck, or both. For example, 200, 250, 300, 350, 400, 450, 500, 600, 700, 800, 900, 1,000, 1,500, 1,800, 2,000, 2,500, 3,000, 3,500, 4,000, 4,500, 5,000, 5,500, 6,000, 6,500, 7,000, 7,500, 8,000, 8,500, 9,000, 9,500, 10,000 square feet.

In some aspects of the techniques described herein, the sustainable dwelling system may be up to 3,000 square feet of indoor living and dwelling space and may be on land up to 20 acres. For example, 200, 300, 400, 500, 600, 700, 800, 900, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000 square feet of indoor dwelling. For example, 1, 2, 3, 4, 5, 6, 7, 8, 9, 10, 11, 12, 13, 14, 15, 16, 17, 18, 19, 20 acres of land space.

In some aspects of the techniques described herein, the disclosed sustainable dwelling system integrates advanced artificial intelligence (AI)-driven automation, modular construction, security enhancements, and next-generation energy sustainability to provide a self-sufficient, disaster-resilient, and highly adaptive living space. Unlike conventional bunker systems or sustainable dwellings, this system dynamically adapts to environmental, security, and occupant needs through real-time AI monitoring, quantum energy harvesting, and biometrically controlled smart infrastructure.

In some aspects of the techniques described herein, the dwelling system incorporates an AI-powered resource optimization network that autonomously regulates energy distribution, water filtration, waste management, and climate control based on real-time inputs from multiple sensors. The AI system continuously predicts potential catastrophic events such as natural disasters, geopolitical crises, cyber intrusions, and electromagnetic pulses (EMPs) and autonomously deploys countermeasures such as structural reinforcements, Faraday cage enclosures, and secure lockdown procedures. Additionally, the system includes a predictive AI-driven food production module that optimizes hydroponic, aeroponic, and aquaponic farming within the dwelling to ensure sustainable food production for long-term self-sufficiency.

In some aspects of the techniques described herein, the dwelling system may be constructed, and the material composition of the sustainable dwelling system offers groundbreaking durability and adaptability. The structure incorporates self-healing biopolymer-infused materials that can autonomously repair cracks, minor structural damage, and wear caused by environmental stressors or physical impact. Moreover, modular underground expansion is facilitated through an AI-calibrated climate-controlled bunker system, allowing for customized subterranean living configurations. The outer surfaces of the dwelling are embedded with photochromic and electrochromic materials that function as a dynamic camouflage system, incorporating photochromic and electrochromic coatings that adjust color, reflectivity, and thermal signature autonomously, adapting the exterior appearance to match its surroundings for enhanced visual concealment and security.

### Security Network

In some aspects, the techniques described herein relate to a security network, which may include at least one nuclear containment rooms/s or unit/s, wherein the nuclear containment unit/s may be indoors. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 units.

In some aspects of the techniques described herein, the security network may have nuclear containment unit/s with or without anti-radiation suits, etc.

In some aspects, the techniques described herein relate to a security network that may include an indoor dwelling bunker-style building structure integrated with residential-style building structures and at least one outdoor outpost and/or tower. For example, 1, 2, 3, 4, 5, 6, 7, 8, 9, 10, 11, 12, 13, 14, 15, 16, 17, 18, 19, 20, etc. outpost and/or towers.

In some aspects, the techniques described herein relate to a security network that may include the bunker-style building structure may be reinforced with concrete and steel, wherein the bunker-style building structure may be at least ten feet below the ground surface or underground, for example, 1, 2, 3, 4, 5, 6, 7, 8, 9, 10 feet below ground.

In some aspects of the techniques described herein relate to a security network that may include the bunker-style building structure may be one or more bunker systems, which may be a minimum and/or no impact of any bomb explosions.

In some aspects of the techniques described herein, the security network may have bunker systems with nuclear containment unit/s and/or anti-radiation suits.

In some aspects of the techniques described herein, the security network comprises at least one nuclear containment unit, for example, 1, 2, 3, 4, 5, 6, 7, 8, 9, 10, 11, 12, 13, 14, 15, 16, 17, 18, 19, 20, 21, 22, 23, 24, 25, and any combination thereof.

In some aspects of the techniques described herein, the containment unit is indoor air-tight and/or sealed.

In some aspects, the techniques described herein relate to a security network may include at least one electronic equipment security subnetwork, wherein the equipment security subnetwork may include one or more from a group consisting of television (LED, OLED, QLED), laptop and desktop computers, smartphones, tablets, home theater systems, Bluetooth speakers, smart speakers, routers, and modems, gaming consoles, PlayStation and Xbox, smart thermostats, smart light bulbs, and smart lighting systems, refrigerators, microwave ovens, washing machines, dryers, dishwashers, coffee makers, blenders, food processors, electric ovens, toaster ovens, air conditioners, space heaters, vacuum cleaners, robotic vacuums, Roomba, electric fans, electric toothbrushes, hair dryers, electric shavers, irons, dehumidifiers, humidifiers, air purifiers, alarm clocks, smart clocks, security cameras, home surveillance systems, smart doorbells, electric fireplaces, portable power banks, home printers, scanners, smart plugs, smart outlets, etc., and combination thereof.

In some aspects, the techniques described herein relate to a security network may include at least one electronic equipment security subnetwork configured to block electromagnetic pulse/radiation from entering indoor dwelling space, and wherein the blocking may be configured via one or more selected from a group consisting of Faraday cage, EMI Shielding (Electromagnetic Interference Shielding), Mu-Metal Shielding, Conductive Enclosures, Shielded Rooms, RF Shielding, Gasket Seals, and any combination thereof.

In some aspects of the techniques described herein, the security network may be designed to protect electronic equipment from electromagnetic pulses (EMP), which can disable electronics and communication systems.

In some aspects of the techniques described herein, the security network may be designed to protect electronic equipment from electromagnetic pulses (EMP) via Farraday Cage. The primary function of a Faraday cage may be to serve as a protective enclosure, blocking specific types of electromagnetic radiation from entering or escaping its interior.

In some aspects, the techniques described herein relate to a security network may include at least one electronic equipment security subnetwork; for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500 subnetworks.

In some aspects, the techniques described herein relate to the security network that may include the living space dynamically adapting based on occupant activity, privacy needs, and emergency scenarios. Biometrically adaptive entry systems utilize multi-factor authentication, combining fingerprint, retina scan, gait recognition, and voice patterns to grant or restrict access to specific areas of the dwelling. The smart interior partitions may be designed with motorized, robotic walls and furniture, allowing users to reconfigure spaces dynamically for multi-purpose use, such as emergency lockdown, communal gatherings, or isolated medical treatment zones. Additionally, an AI-managed waste-to-resource system is incorporated, featuring a bioreactor that converts organic waste into renewable biofuel and compost for continued agricultural sustainability.

In some aspects, the techniques described herein relate to the security network that may include armored-resistant and armored-proof materials selected from one or more from a group consisting of fiberglass, synthetic fiber, Kevlar, Dyneme, ultra-high-molecular-weight polyethylene (UHMWPE), Ceramic, alumina and silicon carbide, Steel, Carbon Nanotubes, Titanium, Aluminum Oxide, Polycarbonate, Composite Armor, a combination of ceramics, metals, and fibers, Graphene, and any combination thereof.

In some aspects of the techniques described herein relate to a security network may have hunting box blinds with the deluxe stairs/rail system, which may be used for hunting and/or overall protection.

In some aspects of the techniques described herein relate to a security network may that have outer-self-sustainable living and dwelling system structures; these structures may include outpost, outer towers, outer fencing, tree-houses, outer sheds, outer dens, tec., and any combination thereof.

In some aspects of the techniques described herein, outer-self-sustainable living and dwelling system structures may be made from long-lasting fiberglass with, without, or a combination of both a durable gel-coat finish. The fiberglass bottom prevents rotting and varmint damage.

In some aspects of the techniques described herein, outer-self-sustainable living and dwelling system structures may be made of up to 5 inches of roof overhang (for example, 1, 2, 3, 4, or 5 inches) and window drip edge to help keep rain off the windows and may give a clear view of the outside, such as hunting grounds.

In some aspects of the techniques described herein, outer-self-sustainable living and dwelling system structures may have at least one interior of the blind that may have a closed-cell foam insulated ceiling, acoustical foam-covered walls, and a high-density foam pad underneath a marine-carpeted floor-to provide superior sound control and insulation.

In some aspects of the techniques described herein, outer-self-sustainable living and dwelling system structures may have one or more blind/s that may have 1, 2, 3, 4, 5, 6, 7, 8, 9, 10, or more gear consoles and/or shelves with gun/s holders. These may assist in organizing the blind.

In some aspects of the techniques described herein, outer-self-sustainable living and dwelling system structures may have out to ten green LED Lights under the front of the ger console and/or shelves. For example, 1, 2, 3, 4, 5, 6, 7, 8, 9, and 10 lights.

In some aspects of the techniques described herein, outer-self-sustainable living and dwelling system structures may have large tinted, tempered automotive-glass windows with whisper-quiet window hinges to provide a clear view.

In some aspects of the techniques described herein, outer-self-sustainable living and dwelling system structures may have one or more high-quality automotive window gaskets and door molding to help keep your scent in, the blind dry, and the pests out. For example,

1, 2, 3, 4, 5, 6, 7, 8, 9, 10, 11, 12, 13, 14, 15, 16, 17, 18, 19, 20 window gasket and door molding.

In some aspects of the techniques described herein, outer-self-sustainable living and dwelling system structures may have a fiberglass bottom to prevent rotting and varmint damage.

In some aspects of the techniques described herein, the outer-self-sustainable living and dwelling system hunting box may have a 5-inch roof overhang, for example, 0.5, 1.5, 2, 2.5, 3, 3.5, 4, 4.5, 5 inches.

In some aspects of the techniques described herein, an outer-self-sustainable living and dwelling system hunting box may have a window-covering drip edge to help keep the rain off the windows. The drip further may provide the sustainable living and dwelling system occupant with a clear view of the outside grounds.

In some aspects of the techniques described herein, an outer-self-sustainable living and dwelling system hunting box may have an interior, exterior, or both may have a coating such as closed-cell foam-insulated, acoustical foam-covered, a high-density foam pad, etc., or any combination thereof to provide superior sound control and insulation.

In some aspects of the techniques described herein, the outer-self-sustainable living and dwelling system hunting box may have one or more, for example, two, three, four, five, six, seven, eight, nine, etc.) gear consoles and/or shelves with or without gun holders to help organize.

In some aspects of the techniques described here, an outer-self-sustainable living and dwelling system hunting box may have one or more (e.g., 2, 3, 4, 5, 6, 7, 8, 9, 10) lights (e.g., green, red, blue, white, or any combination thereof LED). The lights may be located under the front, back, top, bottom, left side, right side, or any combination thereof.

In some aspects of the techniques described herein, the outer-self-sustainable living and dwelling system hunting box may be tinted with tempered automotive-glass windows and whisper-quiet window hinges to provide a clear view.

In some aspects of the techniques described herein, the outer-self-sustainable living and dwelling system hunting box may have high-quality automotive window gaskets and door molding to help keep the occupant's scent in, the window-covering and window dry and the pests out.

In some aspects of the techniques described herein, the outer-self-sustainable living and dwelling system hunting box may have vertical, horizontal, or both glass windows for bow, crossbow, or gun hunting.

In some aspects of the techniques described herein, the outer-self-sustainable living and dwelling system hunting box may have a silk screen black camo pattern on the lower half of vertical windows to help block views from outsiders, such as humans, deer, other game animals, etc., or any combination thereof.

In some aspects of the techniques described herein, outer-self-sustainable living and dwelling system hunting box's window, doors, walls, ceiling, floors, etc., or any combination thereof may have an interior, exterior, or both coating such as closed-cell foam-insulated, acoustical foam-covered, a high-density foam pad, etc., or any combination thereof. Furthermore, the coating provides superior sound control and insulation, especially underneath a marine-carpeted floor.

In some aspects of the techniques described herein, the security network may have one or more shooting ports at various locations within the system, outer-self-sustainable living and dwelling systems, outer structure, etc., or any combination thereof. These shooting ports may be automatically, manually, opened-closed, or both; the opening-closing may be automatic, on-demand, or both. For example, 1, 2, 3, 4, 5, 6, 7, 8, 9, 10, 11, 12, 13, 14, 15, 16, 17, 18, 19, 20, etc. shooting ports.

In some aspects of the techniques described herein relate to a security network may have outer-self-sustainable living and dwelling system structures. These outer-self-sustainable dwelling and living and dwelling system structures may have hunting box blinds with the deluxe stairs/rail system, which may be used for hunting and/or overall protection.

In some aspects, the techniques described herein relate to a security network that may include window-coverings and doors-coverings, wherein the coverings have at least one Gear Consoles and shelves with gun holders configured to organize the coverings. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, coverings and any combination thereof.

In some aspects, the techniques described herein relate to a security network that may include window-coverings and doors-coverings, wherein the coverings have at least one Gear Consoles and shelves with gun holders configured to organize the coverings. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, Gear Consoles, and any combination thereof.

In some aspects, the techniques described herein relate to a security network that may include roof overhangs and window drip edge/s configured to protect the dwelling from rainwater and may or may not be linked to the rain catchers.

In some aspects, the techniques described herein relate to a security network that may independently or jointly with an energy management network form and include a closed-cell foam-insulated ceiling, acoustic foam-covered walls, and a high-density foam pad underneath a marine-carpeted floor configured to provide insulation and sound security.

In some aspects of the techniques described herein, the security network may have a secure safe room/s for legal gun/s, ammunition/s, etc., or any combination thereof.

In some aspects of the techniques described herein, the security network may have a fully equipped defense station in the attic to cover one or more (for example, 1, 2, 3, 4, 5, 6, 7, 8, 9, 10, 11, 12, 13, 14, 15, 16, 17, 18, 19, 20, etc.) sides with the shooting ports.

In some aspects of the techniques described herein, the sustainable dwelling system' a security network, or a part thereof may be enhanced with various bullet-resistant features; for example, the security network, or part thereof may be made of armored glass, bullet-resistant panels, or both.

In some aspects of the techniques described herein, the security network may have security camera unit/s adapted to monitor or surveillance the dwelling's security. The camera/s may be wired or wirelessly connected to one or more communication networks, surveillance networks, and/or security network's central module/s.

In some aspects of the techniques described herein, the security network may have security camera unit/s may be night vision and weatherproof and be adapted for night-time monitoring, surveillance, and/or security.

In some aspects of the techniques described herein, the security network of the dwelling is significantly reinforced with EMP-resistant, AI-coordinated defense mechanisms.

In some aspect, the security network includes an automated defense drone system equipped with LiDAR, thermal imaging, facial recognition, and biometric authentication to monitor and neutralize potential threats. The cybersecurity subnetwork is blockchain-encrypted, preventing unauthorized digital intrusions. Additionally, electromagnetic pulse (EMP) shielding is achieved through a multi-layered Faraday-cage infrastructure, which prevents electronic disruptions while ensuring continued functionality of critical communication, navigation, and surveillance systems. The security network further includes autonomous robotic perimeter surveillance units and kinetic-response barriers that adjust to evolving threat conditions.

### Air Management Network

In some aspects, the techniques described herein relate to a security network and air management network that may include windows and doors with high-quality automotive window gaskets and door molding adapted to seal the window/s and door/s from an exchange of air between indoor and outdoor air.

In some aspects of the techniques described herein, the security network may be equipped to protect against one or more events involving chemical, biological, radiological, nuclear, etc., or any combination thereof. The network may provide a sealed environment with filtration systems to prevent the infiltration of hazardous substances from one or more such events.

In some aspects, the techniques described herein relate to an air management network that may include at least one air seal/s, air suction ventilator/s, and/or air filter/s, wherein the air seal/s may be adapted to seal indoor dwelling from outdoor dwelling air and may prevent outdoor air from entering indoor and indoor air from escaping to outdoor. The sealing may be up to 99%, and the air suction ventilators may be connected to air filters, wherein the air filters may be selected from a group consisting of biological filters, chemical filters, nuclear filters, and any combination thereof.

In some aspects, the techniques described herein relate to an air management network that may include at least one air suction ventilator/s, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 air suction ventilators.

In some aspects, the techniques described herein relate to an air management network that may include at least one air seal/s, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 air seals.

In some aspects, the techniques described herein relate to an air management network that may include at least one air filter/s, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 air filters.

In some aspects, the techniques described herein relate to an air management network that may seal may be up to 99%. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% sealing.

In some aspects, the techniques described herein relate to an air management network that may include at least one air seal/s, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 air seals.

In some aspects of the techniques described herein, when the air may become contaminated, the air management network and the security network may clean the air.

In case of a disaster, natural and/or man-made, breathable air may become contaminated with biological, chemical, and/or nuclear. The ventilator may suck all the contaminated air, and the air may then pass through the valve and air filters to clean the air. Thus, the air released may become breathable.

Biological contamination may include microbes, dust particles, pollen, Biogenic Volatile Organic Compounds, animal dander, bacteria, viruses, fungi, dust mites, etc., and/or any combination thereof. The air contamination may be chemical such as gases, liquids, or solids Carbon Monoxide (CO), Sulfur Dioxide (SO₂), Nitrogen Oxides (NOₓ), Volatile Organic Compounds (VOCs), Particulate Matter (PM10, PM2.5), Ground-Level Ozone (O₃), Lead (Pb), Ammonia (NH₃), Mercury (Hg), Chlorofluorocarbons (CFCs), Hydrocarbons, Per- and Polyfluoroalkyl Substances (PFAS), etc., and/or any combination thereof. The air contamination may be nuclear fallout; for example, radioactive particles and gases into the atmosphere, Iodine-131 (I-131), Cesium-137 (Cs-137), Strontium-90 (Sr-90), Plutonium (Pu-239), Radon (Rn-222), and/or any combination thereof.

In some aspects of the techniques described herein, the air management network may offer protection from air contaminants via air-tight and/or air-seal and/or air filtration.

In some of the techniques described herein, the air management network may filter air via Nuclear, Biological, and Chemical (NBC) filters, such as activated carbon or other absorbent materials, HEPA (High-Efficiency Particulate Air) filters, or similar technologies that can capture particles as small as 0.3 microns, specialized materials that can trap or absorb radioactive isotopes, etc., and/or any combination thereof. These filter systems may guarantee protection against all forms of air contamination.

In some aspects of the techniques described herein, the air management network may clean air within the bunker network. It may be designed to filter out radiation via one or more filtration systems, such as an NBC Swiss-made air filtering system.

In some aspects of the techniques described herein, the air management network may be equipped with nuclear, biological, and chemical (NBC) filtration systems, utilizing HEPA, activated carbon, and radiation-absorbing composite materials to maintain clean indoor air quality even in contaminated external environments. A secure attic-based defense station is integrated within the dwelling, providing long-range defensive capabilities and tactical oversight of the surrounding area.

### Transportation Network

In some aspects, the techniques described herein relate to the dwelling system's transport network that may include at least one vehicle and fuel required to transport individual/s to and from another secure location, wherein the vehicle is bulletproof.

In some aspects, the techniques described herein relate to the dwelling system's transport network that may include at least one vehicle. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 vehicles.

In some aspects of the techniques described herein, the system incorporates a safe transportation network. The transportation network may provide transportation within the self-sustainable dwelling system, to, from, or between the outpost and/or tower, out of the self-sustainable living and dwelling system, or any combination thereof.

For example, at least one armored bug-out vehicle (Goat Tactical or other) may be stored with customizable fuel storage within the vehicle, outside vehicle storage, or both. The storage capacity may be up to 50 gallons, for example, 5, 10, 15, 20, 25, 30, 35, 36, 37, 38, 39, 40, 41, 42, 43, 44, 45, 46, 47, 48, 49, 50, or any combination thereof.

### Resource Management System

In some aspects, the techniques described herein relate to the dwelling system's resource management network may assist in and may design the dwelling system to support long-term occupancy, ensuring that occupants may survive extended periods without external support with a self-sustainable supply of water, food, medication, etc., or any combination thereof. Thus, the system may serve as a safe haven during times of civil unrest, riots, or invasions.

Some aspects of the techniques described herein relate to the dwelling system's resource management network, which may include a food supply infrastructure including long-term food storage and food renewal modules (e.g., hydroponics, aquaponics, vertical farming), which may provide a replenishable food supply via stored food or grown food on the premises of the sustainable dwelling system, wherein the stored food may be stored in a food storage units for perishable, non-perishable, or both. For example, up to three months of frozen fried food supply for a family of four.

In some aspects, the techniques described herein relate to the dwelling system's resource management network, which may include a food supply infrastructure, including long-term food storage and food renewal modules (e.g., hydroponics, aquaponics, vertical farming). The food supply infrastructure, comprising long-term food storage and food renewal modules (e.g., hydroponics, aquaponics, vertical farming), may include at least one food storage unit/s adapted to store food for up to 50 years; for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 years.

In some aspects, the techniques described herein relate to the food supply infrastructure, comprising long-term food storage and food renewal modules (e.g., hydroponics, aquaponics, vertical farming), which may include at least one food renewal module/s, such as indoor and/or out gardens, aquaponics, hydroponics, waste reduction, food scraps recycling and composting, vertical farming, indoor livestock farming-rabbits, chicken, quail, duck, tilapia, outdoor farming and livestock farming-cattle, sheep, goats, pigs, chickens, turkeys, llamas, alpacas, rabbits, outdoor farming, outdoor fruit trees, etc.

In some aspects, the techniques described herein relate to the food supply infrastructure, comprising long-term food storage and food renewal modules (e.g., hydroponics, aquaponics, vertical farming), which may include at least one food renewal module/s, which may be further configured to grow food (plant and/or animal) on-premises. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 food renewal modules.

In some aspects of the techniques described herein, the resource management network may have water-replenishing infrastructure that may provide water constantly, intermittently, or both as required.

In some aspects of the techniques described herein, the water replenishing infrastructure may have at least one rain-catcher framework that may or may not be attached to one or more gutters.

In some aspects of the techniques described herein, the water replenishing infrastructure may have an underground well framework.

In some aspects of the techniques described herein, the water replenishing infrastructure may have one or more automatic, manual, hand-held pumps, etc., or any combination thereof.

In some aspects of the techniques described herein, the water replenishing infrastructure may have one or more water storage units/tanks, each holding between 50 and 1000 gallons of water. For example, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000 gallons of water.

In some aspects of the techniques described herein, the resource management network may the water supply infrastructure leverages atmospheric water harvesting using graphene-based filtration membranes, ensuring a continuous supply of purified water extracted directly from air moisture, independent of external water sources.

In some aspects of the techniques described herein, the resource management network may be smart interior partitions may be designed with motorized, robotic walls and furniture, allowing users to reconfigure spaces dynamically for multi-purpose use, such as emergency lockdown, communal gatherings, or isolated medical treatment zones.

In some aspects of the techniques described herein, the resource management network may include an AI-managed waste-to-resource system may be incorporated, featuring a bioreactor that converts organic waste into renewable biofuel and compost for continued agricultural sustainability.

In some aspects of the techniques described herein, the resource management network may have one or more bug-out bags, which may have a pack of emergency supplies that may help survive independently for up to a week in the event of an emergency event. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 bug out bags.

### Medical Network

In some aspects of the techniques described herein, the system may have a medical supply and storage system where customizable medical supplies and equipment may be stored for short- or long-term periods. For example, the sustainable living and dwelling system may have a medical room with antibiotics, wound care, trauma care, etc., and/or any combination thereof.

### Energy Management Network

In some aspects of the techniques described herein, an energy management network may have an energy-generating subnetwork, which may or may not be a redundant power subnetwork, and it may use standby generators, solar-powered batteries, or both.

In some aspects of the techniques described herein, the system may have a standby generator with up to a 1000-gallon propane tank. For example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, 803, 804, 805, 806, 807, 808, 809, 810, 811, 812, 813, 814, 815, 816, 817, 818, 819, 820, 821, 822, 823, 824, 825, 826, 827, 828, 829, 830, 831, 832, 833, 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, 919, 920, 921, 922, 923, 924, 925, 926, 927, 928, 929, 930, 931, 932, 933, 934, 935, 936, 937, 938, 939, 940, 941, 942, 943, 944, 945, 946, 947, 948, 949, 950, 951, 952, 953, 954, 955, 956, 957, 958, 959, 960, 961, 962, 963, 964, 965, 966, 967, 968, 969, 970, 971, 972, 973, 974, 975, 976, 977, 978, 979, 980, 981, 982, 983, 984, 985, 986, 987, 988, 989, 990, 991, 992, 993, 994, 995, 996, 997, 998, 999, 1000 gallons.

In some aspects of the techniques described herein, the energy management network may have an energy-generating subnetwork, which may have up to 10 (e.g., 1, 2, 3, 4, 5, 6, 7, 8, 9, 10) line LCD digital controller. The controller may have one or more multilingual digital screens (e.g., English, Spanish, French, Portuguese, etc.). The energy-generating subnetwork may have an external viewing screen or window, which may be digital and easily indicate generator status and breaker position. The controller may be visible and accessible without opening the generator enclosure.

In some aspects of the techniques described herein, the energy management network may have an energy-generating system, which may be capable of being installed within 20 inches (457 mm) of a building. For example, 1, 2, 3, 4, 5, 6, 7, 8, 9, 10, 11, 12, 13, 14, 15, 16, 17, 18, 19, 20 inches.

In some aspects of the techniques described herein, the energy management network may have an energy-generating subnetwork, which uses electrical technology to ensure high-quality power output with up to 6% total harmonic distortion (e.g. 0.5, 1, 1.5, 2, 2.5, 3, 3.5, 4.5, 4.9, 5, 5.5, 6%), making it safe for sensitive electronics.

In some aspects of the techniques described herein, the energy management network may have an energy-generating subnetwork that ensures stable and reliable power output with the isochronous electronic governor so that the energy-generation system maintains engine speed regardless of load changes.

In some aspects of the techniques described herein, the energy management network may have an energy-generating subnetwork that may have a sound-attenuating enclosure to reduce noise levels, making the generator quieter during operation.

In some aspects of the techniques described herein, the energy management network may have an energy-generating subnetwork that may have a closed coolant recovery system.

In some aspects of the techniques described herein, the energy management network may have an energy-generating subnetwork that may have a smart battery charger.

In some aspects of the techniques described herein, the energy management network may have an energy-generating subnetwork with UV/Ozone resistant hoses.

In some aspects of the techniques described herein, the energy management network may have an energy-generating subnetwork with a voltage regulation of +5%, e.g., 0.5, 1, 2, 3, 4, 5%.

In some aspects of the techniques described herein, the energy management network may have an energy-generating subnetwork operated by natural gas, liquefied petroleum, or both.

In some aspects of the techniques described herein, the energy management network may have an energy-generating subnetwork connected to a network (e.g., Wi-Fi, cellular, or both) to enable remote monitoring and control. This may allow users to remotely from any area within sustainable living and dwelling or any far-away area anywhere in the world using a smartphone, tablet, PC, etc., with a similar connectivity to monitor the status of their generator, receive maintenance alerts, manage settings, etc., or any combination thereof from a mobile app or web portal. This connectivity may assist the app or web portal to access information such as the current operating status, the generator's maintenance schedule, etc. Connect the generator's account to an authorized service dealer for fast, friendly, and convenient assistance.

In some aspects of the techniques described herein, the energy management network may have an energy-generating subnetwork that may run at a lower, quieter RPM for up to 20 (e.g., 1, 2, 3, 4, 5, 6, 7, 8, 9, 10, 11, 12, 13, 14, 15, 16, 17, 18, 19, 20 minutes) tests to ensure the system may be running correctly while consuming less fuel. This test may be referred to as Quiet-Test Self-Test mode and may be programmed to run daily, weekly, bi-weekly, monthly, quarterly, six months, annually, etc., or any combination thereof.

In some aspects of the techniques described herein, the energy-generating subnetwork may be made of tough, durable all-aluminum enclosures and may have a powder-coated, which may make the aluminum corrosion-resistant, which may make the aluminum perfect for all weather conditions. The coating may be polyurethane, polyurea-based material, RhinoCoat™, and/or any combination thereof.

In some aspects of the techniques described herein, the energy-maintaining network innovations in the system ensure true off-grid resilience. The roof and exterior walls may be lined with quantum-dot photovoltaic cells that provide efficient solar energy conversion while simultaneously serving as aesthetic camouflage panels. Additionally, the structure integrates energy-storing concrete that enables the walls and floors to function as a thermal battery, passively storing and releasing energy based on indoor temperature fluctuations. The dwelling system also incorporates a kinetic energy harvesting flooring system, converting occupant movement into usable power through piezoelectric technology. The water supply infrastructure leverages atmospheric water harvesting using graphene-based filtration membranes, ensuring a continuous supply of purified water extracted directly from air moisture, independent of external water sources.

### A Tooling Work-Shop Network

In some aspects of the techniques described herein, a tooling workshop network may have one or more tool workshop installations, for example, 1, 2, 3, 4, 5, 6, 7, 8, 9, 10, etc., tool workshops.

In some aspects of the techniques described herein, a tooling workshop network may have a dedicated energy management network and/or energy-generating subnetwork, such as a breaker box, electricity supply, outlets, gasoline-based generators, standby generators, solar-powered batteries, etc.

In some aspects of the techniques described herein, a tooling workshop network may have a tool workshop that may have equipment and materials for woodworking tools, metal tool making, etc., or any combination thereof. For example, machines and hand tools designed for cutting, shaping, and finishing wood, tables, saws, miters, a drill press, a lathe, crafting spindles, bowls, tool handles, routers, planers, jointers, CNC machines, chisels and hand planes, wood rasps, files, sanders, grinders, honing stones, etc., and any combination thereof.

In some aspects of the techniques described herein, a tooling workshop network may be up to 20 feet by 40 feet (800 Square feet). For example, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, 764, 765, 766, 767, 768, 769, 770, 771, 772, 773, 774, 775, 776, 777, 778, 779, 780, 781, 782, 783, 784, 785, 786, 787, 788, 789, 790, 791, 792, 793, 794, 795, 796, 797, 798, 799, 800 square feet. For example, 1, 2, 3, 4, 5, 6, 7, 8, 9, 10, 11, 12, 13, 14, 15, 16, 17, 18, 19, 20 feet by 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40 feet.

### Surveillance Network

In some aspects of the techniques described herein, the system may have a surveillance network that may work with or without the transport network and/or the security network.

In some aspects of the techniques described herein, the surveillance network may have one or more surveillance drone stations, which may be equipped with one or more drones, controls, and accessories.

In some aspects, the techniques described herein relate to the dwelling system with a surveillance network that may include at least one drone and/or at least one outdoor camera. For example, the drones may be 1,2, 3, 4, 5, 6, 7, 8, 9, 10, 11, 12, 13, 14, 15, 16, 17, 18, 19, 20, etc. For example, the cameras may be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, etc.

In some aspects, the techniques described herein relate to the dwelling system with a surveillance network that may include at least one outpost and/or tower and/or at least one fence.

In some aspects of the techniques described herein, the surveillance network may have one or more outposts and/or towers, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 outpost and/or towers.

In some aspects, the techniques described herein relate to the surveillance network that may include outposts and/or tower/s that may or may not be a self-sustainable dwelling and living and dwelling system by itself (that is, with or without the self-sustaining building structures of the dwelling); for example, there may be outer security outposts and/or towers at one or more locations. These outposts and/or towers may be referred to as “outer-self-sustainable dwelling systems” in this disclosure. The towers and outpost may provide additional security and have high-impact, high-strength fencing with manual, automated, or both bollards in strategic locations. They may also provide perimeter security.

In some aspects, the techniques described herein relate to the surveillance network with or without a security network that may include fencing. The fencing may have gaps or gates for a vehicle to enter. The gate/s may be manually or automatically operated such that they open remotely and/or have manual control or direct control.

In some aspects, the techniques described herein relate to the dwelling system with a surveillance network that may include at least one mode of transportation, such as at least one drone and/or at least one vehicle.

### Communication/Automation Network

In some aspects of the techniques described herein, the dwelling system may have secure communication centers, which may serve as safe locations for critical communication infrastructure, ensuring continuity of operations when external communication networks malfunction and/or non-function during short-term or long-term disasters such as natural disasters, civil unrest, nuclear war, pandemics, etc. All communication centers may have VHF Radios, Satellite phones, Iridium extreme satellite phone, and any combination thereof.

In some aspects of the techniques described herein, the dwelling systems' automation network may have VHF radio/s, satellite phone/s that may have one or more features such as weather resistance, Built-in GPS, One-touch S.O.S. button in case of emergency, Hands-free earpiece, and any combination thereof.

In some aspects of the techniques described herein, the automation network may be customizable, pre-settable, automatable, and any combination for one and/or more equipment and instruments, including but not limited to phones, satellite phones, radio, remote controls, direct controllers, and any combination thereof.

In some aspects of the techniques described herein, the automation network may have one or more features such as pole-to-pole global voice, short messaging, 2.4 kbps circuit-switched data, short-burst data communication services, built-in GPS, text, automatically text, automatic/customizable breadcrumb of trailing tracks, and any combination.

In some aspects of the techniques described herein, the system may have command and control centers, which may function as command-and-control centers as they may be stocked with satellite phones and other forms of communication.

In some aspects of the techniques described herein, the system may have preservation of critical infrastructure, which integrates essential infrastructure, such as power generators, such that the self-sustainable system may function during and after catastrophic events.

In some aspects of the techniques described herein, the dwelling system, bunker system, outer-self-sustainable living and dwelling system structures, and/or buildings may have one or more automatic lighting.

In some aspects of the techniques described herein, the dwelling system, bunker system, outer-self-sustainable living and dwelling system structures, and/or buildings may have one or more automatic windows, window coverings, door, door-covering, and any combination thereof.

In some aspects of the techniques described herein, the dwelling system, bunker system, outer-self-sustainable living and dwelling system structures, and/or buildings may have one or more parts of the security network.

In some aspects of the techniques described herein, the dwelling system, bunker system, outer-self-sustainable living and dwelling system structures, and/or buildings may have one or more parts of the transportation network.

In some aspects of the techniques described herein, the dwelling system, bunker system, outer-self-sustainable living and dwelling system structures, and/or buildings may have one or more parts of the medical network.

In some aspects of the techniques described herein, the dwelling system, bunker system, outer-self-sustainable living and dwelling system structures, and/or buildings may have one or more parts of the energy management network.

In some aspects of the techniques described herein, the dwelling system, bunker system, outer-self-sustainable living and dwelling system structures, and/or buildings may have one or more parts of the tooling workshop network.

In some aspects of the techniques described herein, the dwelling system, bunker system, outer-self-sustainable living and dwelling system structures, and/or buildings may have one or more parts of the waste management network.

In some aspects of the techniques described herein, the dwelling system, bunker system, outer-self-sustainable living and dwelling system structures, and/or buildings may have one or more parts of the air management network.

In some aspects of the techniques described herein, the dwelling system, bunker system, outer-self-sustainable living and dwelling system structures, and/or buildings may have one or more parts of the surveillance network.

In some aspects of the techniques described herein, the dwelling system, bunker system, outer-self-sustainable living and dwelling system structures, and/or buildings may have one or more parts of the resource management network.

In some aspects of the techniques described herein, the dwelling system, bunker system, outer-self-sustainable living and dwelling system structures, and/or buildings may have one or more parts of the bunker network.

In some aspects of the techniques described herein, the dwelling system, bunker system, outer-self-sustainable living and dwelling system structures, and/or buildings may have one or more parts of the outer-self-sustainable living and dwelling system structures network.

In some aspects of the techniques described herein, the dwelling system, bunker system, outer-self-sustainable living and dwelling system structures, and/or buildings may have the sustainable dwelling system engineered for extreme event survivability. The bunker system is designed with blast-resistant reinforced concrete and carbon-nanotube-reinforced steel alloys, ensuring protection from high-impact forces, nuclear fallout, and seismic activity. The air management network is equipped with nuclear, biological, and chemical (NBC) filtration systems, utilizing HEPA, activated carbon, and radiation-absorbing composite materials to maintain clean indoor air quality even in contaminated external environments. A secure attic-based defense station is integrated within the dwelling, providing long-range defensive capabilities and tactical oversight of the surrounding area.

### Waste Management Network

The dwelling system may have one or more waste management networks to store, detoxify, and/or dispose of waste created during any catastrophic event/s.

In some aspects of the techniques described herein, the waste management network may have one or more storage units for generated waste.

In some aspects of the techniques described herein, the waste management network may have one or more composting units.

In some aspects of the techniques described herein, the waste management network may have one or more septic tank composting toilets, aerobic treatment units, constructed wetlands, mound systems, sand filter systems, recirculating toilets, greywater systems, holding tanks, incinerating toilets, drip distribution systems, and any combination thereof.

### Dynamic Camouflage System

The dynamic camouflage system, incorporating photochromic and electrochromic coatings that adjust color, reflectivity, and thermal signature autonomously is an adaptive interior and/or exterior technology that utilizes photochromic and electrochromic coatings to alter the dwelling's and/or part thereof color, reflectivity, and thermal signature in response to environmental conditions, enhancing concealment, reducing detectability, AI, and/or automatically regulated.

The dynamic camouflage system, incorporating photochromic and electrochromic coatings that adjust color, reflectivity, and thermal signature autonomously may be a protective and concealment feature integrated into the inner and/or outer parts, such as those not limited to the walls, floor, window, doors, walls, ceiling, molding, fences, posts, outdoor living, protective parts, indoor parts, furniture, equipment, appliances, etc., and/or any combination thereof of the dwelling structure. This system may utilize photochromic and electrochromic coatings that dynamically adjust color, reflectivity, and thermal signature in response to environmental conditions. The coatings may alter their optical properties based on factors such as light intensity, temperature, and electromagnetic signals, allowing the dwelling to blend into its surroundings and reduce detectability.

In some embodiments, the system may be linked to an AI-driven environmental sensor network that autonomously regulates the camouflage adjustments in real time, optimizing concealment based on the current landscape and threat levels. This adaptive capability may enhance the security and stealth of the self-sustaining dwelling system, making it particularly effective in high-risk or disaster-prone environments.

In some embodiments, the system may be linked to an AI-driven environmental sensor network that autonomously regulates indoor and/or outdoor colors for beautification and/or customization.

In some embodiments, it may operate autonomously, manually through AI-driven or non-AI-driven, and/or sensors that adjust its properties based on AI or automation manually to customizable colors or designs.

In some embodiments, the outer-self-sustainable dwelling system structures incorporate dynamic camouflage technology to enhance stealth, security, and environmental adaptability. These structures utilize photochromic and electrochromic coatings that dynamically adjust color, reflectivity, and thermal signature in response to surrounding conditions, enabling the dwelling to blend seamlessly with its environment. The photochromic coatings react to changes in light intensity, allowing the exterior to darken or lighten as needed, while electrochromic materials enable active control over reflectivity and infrared emissions, reducing visibility in both visual and thermal spectrums.

In some embodiments, the adaptive camouflage system provides concealment from potential threats and contributes to energy efficiency by regulating solar heat absorption and reflection based on climate conditions. By integrating this technology, the dwelling enhances its resilience in both urban and remote settings, offering an advanced solution for covert disaster preparedness, military applications, and sustainable off-grid living.

### Self-Healing Structural Material Layer

The self-healing structural material layer, utilizing biopolymer-infused concrete or nanocomposite materials to repair cracks and fractures automatically, may be an advanced biopolymer-infused concrete or nanocomposite material designed to repair structural damage autonomously. This layer may embedded within the dwelling's walls, floors, doors, and inner and/or outer parts, such as those not limited to the walls, floor, window, molding doors, walls, ceiling, fences, posts, outdoor living, protective parts, indoor parts, furniture, equipment, appliances, etc., and/or any combination thereof and other load-bearing components to enhance durability and longevity. The self-healing mechanism is activated when cracks, fractures, or minor deformations occur due to environmental stressors such as seismic activity, temperature fluctuations, mechanical impact, etc., and/or any combination thereof.

In some embodiments, the biopolymer agents or nanocomposites within the material react with moisture or carbon dioxide in the atmosphere, triggering a chemical process that fills in cracks and restores the material's integrity. Alternatively, embedded microcapsules containing repair agents may rupture upon structural damage, releasing a sealant that bonds with the surrounding material. This technology prolongs the lifespan of the dwelling and reduces the need for manual repairs, making it particularly valuable in long-term, self-sustaining environments.

In some embodiments, the self-healing structural material layer, utilizing biopolymer-infused concrete or nanocomposite materials to repair cracks and fractures automatically, is a biopolymer-infused concrete or nanocomposite-based system designed to autonomously repair cracks, fractures, and minor structural damage using embedded microcapsules, self-sealing polymers, or bacteria-based mineralization. This feature enhances durability, reduces maintenance, and extends the lifespan of the dwelling, ensuring structural integrity even in extreme conditions.

### AI-Powered Resource Management System

The AI-powered resource management system, which optimizes energy, water, waste, and climate control is an autonomous intelligence network that optimizes all aspects of the indoor, outdoor, above, and/or underground dwelling, such as, but not limited to, energy management network and energy use, water management, a waste management network and waste processing, security network, climate control, transportation network, medical network, automation network, tooling work-shop network, an air management network, a surveillance network, a resource management network, etc., and/or any combination thereof by dynamically adjusting resources based on real-time near-real-time, short, long-term data (and/or any combination thereof) and predictive analytics.

The disclosed self-sustaining dwelling system may integrate advanced artificial intelligence (AI) and sustainable resource management technologies to provide a fully autonomous living environment optimized for disaster resilience and short, and/or long-term habitation. The AI-powered resource management system, which optimizes energy, water, waste, and climate control, continuously monitors and adjusts various aspects of the indoor and/or outdoor dwelling, such as but not limited to energy management network and energy use, water management, a waste management network and waste processing, security network, climate control, transportation network, medical network, automation network, tooling work-shop network, an air management network, a surveillance network, a resource management network, etc., and/or any combination thereof in response to real-time environmental conditions and occupant behaviors, ensuring efficiency and sustainability.

Integrating an underground bunker with an AI-calibrated climate control system provides a safe and habitable refuge in extreme conditions while self-healing structural materials enhance durability by autonomously repairing environmental damage. The system also incorporates advanced security features, including an autonomous drone-based surveillance network with LiDAR and facial recognition capabilities, an EMP-shielded infrastructure protected by a multi-layered Faraday cage, and a blockchain-encrypted cybersecurity system securing all digital communication and access controls. Further enhancing the dwelling's resilience, the renewable energy harvesting network includes a high-efficiency quantum-dot photovoltaic panel array, energy-storing concrete infrastructure, and kinetic energy harvesting flooring, ensuring a continuous power supply even in off-grid conditions. The sustainable water generation and purification system employs atmospheric water harvesting with graphene-based filtration membranes, while the AI-managed waste conversion system transforms organic waste into biofuel and nutrient-rich compost, supporting a closed-loop agricultural ecosystem.

The AI-powered resource management system, which optimizes energy, water, waste, and climate control is an autonomous intelligence network configured to optimize and regulate all aspects of the dwelling, such as but not limited to various aspects of the indoor and/or outdoor dwelling, such as but not limited to the energy management network and energy use, water management, a waste management network and waste processing, security network, climate control, transportation network, medical network, automation network, tooling work-shop network, an air management network, a surveillance network, a resource management network, etc., and/or any combination within the self-sustaining dwelling. This system continuously monitors occupant activity and environmental conditions through a network of smart sensors, IoT devices, smartphones, and machine learning algorithms. The AI dynamically adjusts lighting, heating, cooling, food supply, waste material, indoor and/or outdoor colors, ventilation, etc., and/or any combination thereof based on real-time, near-time, short-term, and/or long-term data to improve the efficiency and comfort of one or more aspects of the dwelling.

In some embodiments, the system manages water resources by regulating atmospheric water harvesting, filtration, and recycling processes to ensure a sustainable supply for drinking, sanitation, and irrigation.

In some embodiments, the AI further coordinates waste conversion, utilizing microbial bioreactors to transform organic waste into renewable biofuel and compost.

In some embodiments, predictive algorithms anticipate resource demand and adjust distribution accordingly, ensuring optimal efficiency even in extreme conditions. By integrating automation, predictive analytics, and self-regulating resource allocation, this system significantly enhances the autonomy and sustainability of the dwelling.

In some embodiments, the AI-powered resource management system, which optimizes energy, water, waste, and climate control is an autonomous, intelligent control network designed to optimize and regulate energy consumption, water usage, waste processing, and/or various aspects of the indoor and/or outdoor dwelling, such as but not limited to energy management network and energy use, water management, a waste management network and waste processing, security network, climate control, transportation network, medical network, automation network, tooling work-shop network, an air management network, a surveillance network, a resource management network, etc., and/or any combination, etc., and any combination thereof within the self-sustaining dwelling.

In some embodiments, the system dynamically adjusts 1 lighting, heating, cooling, food supply, waste material, water distribution, indoor and/or outdoor colors, ventilation, etc., and/or any combination thereof, and/or various aspects of the indoor and/or outdoor dwelling, such as but not limited to the energy management network and energy use, water management, a waste management network and waste processing, security network, climate control, transportation network, medical network, automation network, tooling work-shop network, an air management network, a surveillance network, a resource management network, etc., and/or any combination using real-time, near-time, short-term, long-term data from environmental sensors, occupant behavior analytics, and predictive algorithms to maximize efficiency and sustainability.

In some embodiments, it manages renewable energy harvesting, monitors atmospheric water generation, and coordinates waste-to-energy conversion through automated processes.

In some embodiments, the AI system integrates with blockchain-encrypted cybersecurity networks and other automated subsystems to ensure a seamless, self-regulating living environment with minimal manual intervention.

In some embodiments, the modular, AI-enhanced disaster-resistant dwelling system is designed to provide adaptive security, advanced automation, and emergency response capabilities for extreme environmental and geopolitical conditions. The system features a biometrically adaptive access control system utilizing multi-factor authentication methods such as fingerprint recognition, retina scans, gait analysis, and voiceprint verification to regulate access dynamically based on security threat levels and user authentication history. The reconfigurable smart interior includes motorized, robotic partitions and transformable furniture to optimize space utilization, allowing for emergency lockdown scenarios, expanded communal areas, or designated medical isolation zones. A high-resilience underground bunker network, reinforced with blast-resistant concrete and carbon-nanotube-enhanced steel alloys, ensures structural integrity against physical impacts, while integrated nuclear, biological, and chemical (NBC) air filtration systems provide protection against hazardous airborne contaminants. Additionally, the AI-guided transportation network includes at least one armored bug-out vehicle with autonomous navigation and emergency evacuation capabilities, supplemented by a drone-based cargo delivery system capable of autonomously restocking essential supplies such as food, medical equipment, and power reserves. This system offers a comprehensive solution for long-term disaster preparedness and autonomous living by combining AI-driven security, energy autonomy, and modular adaptability.

### DETAILED DESCRIPTION OF THE FIGURES

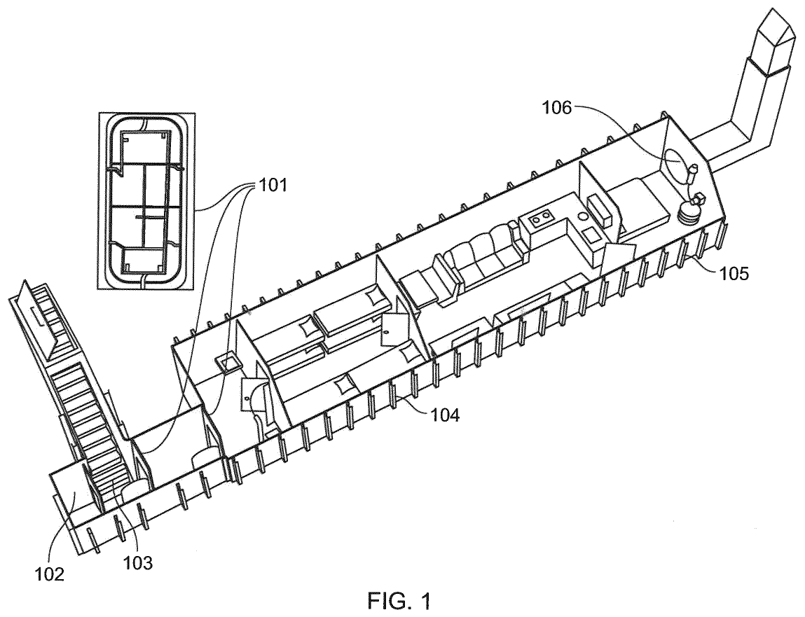

FIG. 1. This depicts a cross-sectional view of an underground shelter or survival bunker network. Key labeled features include-Gas Tight Interior Doors [101]. These doors are designed to prevent the infiltration of gases, providing a sealed and secure environment. Escape Tunnel is an exit tunnel located at the far end of the structure that allows escape during an emergency. The ¼″ Steel Walls are bunker walls made of thick steel for added protection; the steel wall may be, for example, 0.1, 0.15, 0.2, 0.25, 0.3, 0.35, 0.4, 0.45, 0.5″ and any combination thereof. The structure also has 6″ Structural Channel Reinforcements using structural channels for stability and durability, for example, 0.5, 1, 1.5, 2, 2.5, 3, 3.5, 4, 4.5, 5, 5.5, 6″ and any combination thereof. Generator Room [102] is a designated area for housing a generator to supply power. L-Shaped Entrance to Attenuate Gamma Radiation The entrance has an L-shape design to reduce radiation exposure, enhancing safety. Interior layout also includes bunk beds for sleeping, a seating area with a couch, a kitchen space with a sink and counter, and additional living and dwelling space. The design focuses on security, radiation shielding, sustainable living, and dwelling provisions within a confined space during a catastrophic event/s. Although the figure shows an underground bunker network, the same features may be used for above-ground indoor space.

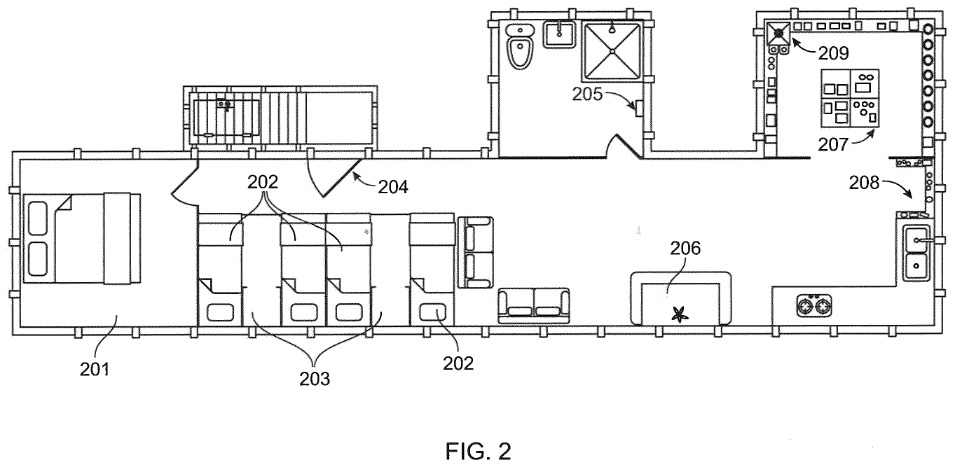

FIG. 2. This shows a top-down layout plan of an underground shelter or survival bunker network. Key features or components include: A master bedroom with a private sleeping area with a large bed. Bunk Beds and Closets [2002. 203]: Multiple bunk beds with individual closets, providing sleeping accommodations for several occupants. Staircase and Bullet-Resistant Door [[204] is a secure shelter entrance through a staircase leading to a reinforced, bullet-resistant door. The bathroom area includes a toilet, sink, and shower; a water heater is also indicated in this section for plumbing support. The food/Water Storage Room is a dedicated space for storing essential supplies such as food, water, medications, valuables, etc., shown with shelves and organized storage containers. NBC Air Filtration System is an air filtration unit designed for protection against nuclear, biological, and chemical contaminants. The pantry [[208] is an additional space adjacent to the storage room, which provides further storage area for essentials and valuables supplies. A bench-style dining table is a seating area with a bench-style table for meals or communal activities. Living and dwelling Area with Sofas is a space furnished with couches for relaxation or socializing. This layout prioritizes safety, comfort, and long-term survival amenities within a secure, self-contained environment. Although the FIG. shows an underground bunker network, the same features for above-ground indoor space.

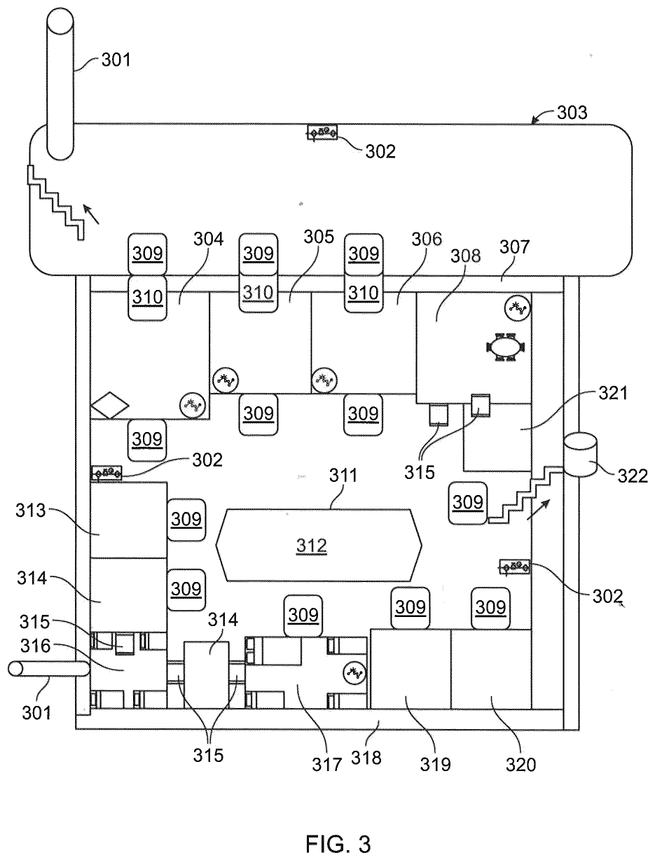

FIG. 3. This FIG. is a detailed schematic layout of an underground survival shelter, labeled with various functional areas and security features. The layout emphasizes protection, storage, and long-term survivability. The key features are: Escape Hatch [301], two escape routes in this example, one at the top left and another at the bottom left, provide emergency exits through staircases. An air filtering system is a multiple system located near key rooms to ensure clean air and protect against nuclear, biological, and chemical threats. Nuclear Containment Room with Suits [303, 319] is a specialized area equipped with anti-radiation suits for hazardous situations. Vault Security Doors are for securing various rooms within the shelter, enhancing overall security and controlled access. Murphy/hidden doors provide security and privacy during a catastrophic event. Medical/Trauma Room with Ensuite Bathroom is a medical facility for treating injuries, including an attached bathroom. Gun/Ammo Room is a dedicated room for storing firearms, ammunition, and other security equipment. Communication Room and Command Center is a central hub for surveillance, monitoring, and drone control, supporting situational awareness and security. The Root Cellar/Canning Room/Hydroponic/Indoor Garden is a space designated for food preservation, growing, and storage, such as canned foods, root vegetables, growing herbs, plants, etc. The living and dwelling room is a communal space for relaxation and social activities. In this example, the bedrooms [316, 317] are two rooms for sleeping quarters with beds for occupants. Two bathrooms are strategically placed for convenience and joined by door/s [315]. The kitchen is a food preparation area with adjacent general storage rooms for supplies. A bulletproof Firewall [307, 318] is a reinforced wall separating secure areas from other parts of the shelter. The Bunker Entrance is the primary access point, secured by stairs leading underground and protected by reinforced doors [309]. The entire structure features 12-inch reinforced concrete walls for durability and protection against external threats, making it a comprehensive and highly fortified survival space [318], for example, 1, 2, 3, 4, 5, 6, 7, 8, 9, 10, 11, 12″ and any combination thereof. In some aspects of the techniques described herein, this structure is above ground with additional structures below ground, and the entrance for such an underground bunker is through a secure door and staircase, which may be at [311]. Additional storage space for the waste, fuel, vehicle, etc. is the management network may have one or more storage units for generated waste and may act as a storage fuel vehicle, etc. Although the figure shows an underground bunker network, the same features may be used for above-ground indoor space.

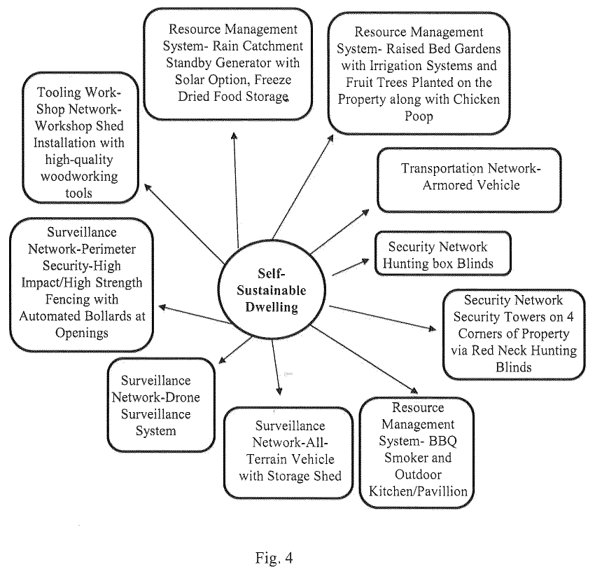

FIG. 4. This is a flowchart depicting the layout of an example of a “self-sustainable turn-key dwelling” designed for self-sufficiency, security, and survival. The central node is labeled “self-sustainable turn-key dwelling,” with various interconnected components that detail the dwelling's features. These are the features/key components, including, but not limited to, a resource management network redundant system that includes a rain catchment, water storage unit/tanks, a standby generator with solar option, and freeze-dried food storage. Systems ensuring long-term sustainability, including renewable water collection or replenishment, backup power, and food preservation.

A surveillance network for outer-self-sustainable dwelling systems, where one aspect is that the perimeter security includes a high impact/high strength fencing with outposts, towers, and automated bollards at openings. Reinforced fencing for property protection, with automated access points for controlled entry and exit.

The security network for the outer-self-sustainable dwelling and living and dwelling system structures may have hunting box blinds with the deluxe stairs/rail system, which may be used for hunting and/or overall protection. The hunting box blinds may be elevated and designed for wildlife hunting or property surveillance. Security towers on four corners of the property via hunting box blinds. Strategic towers are equipped for comprehensive surveillance and security.

A transportation network with one or more armored vehicles. A vehicle for enhanced mobility and protection in dangerous scenarios. All-terrain vehicles (ATV) for transportation within the property, with a dedicated storage area. Drone Surveillance System. A system for aerial monitoring and enhanced situational awareness.

A resource management system has a food supply infrastructure, comprising long-term food storage and food renewal modules (e.g., hydroponics, aquaponics, vertical farming), which may include at least one food renewal module/s, such as indoor and/or out gardens, aquaponics, hydroponics, waste reduction, food scraps recycling and composting, vertical farming, indoor livestock farming-rabbits, chicken, quail, duck, tilapia, outdoor farming and livestock farming-cattle, sheep, goats, pigs, chickens, turkeys, llamas, alpacas, rabbits, outdoor farming, outdoor fruit trees, etc. This may further have outdoor and/or indoor cooking equipment, such as a BBQ smoker and outdoor kitchen/pavilion. A setup for outdoor cooking, entertainment, and food preparation. Raised bed gardens with automated irrigation systems and fruit trees are planned on the property, along with a chicken coop.

A sustainable agriculture setup, including gardens, fruit trees, and chicken poop for fresh produce and protein. A tooling workshop network with workshop shed installation and high-quality woodworking tools: a workshop equipped with tools for property maintenance and craftsmanship. This layout focuses on preparedness, with features for self-reliance, robust defense, and long-term living and dwelling capabilities in emergencies or remote conditions.

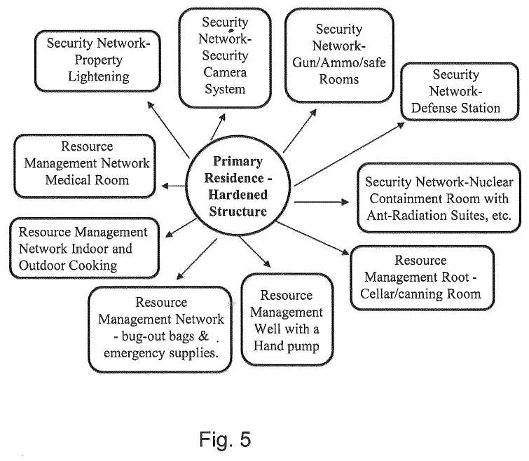

FIG. 5. This flowchart represents the layout of a “primary residence,” a hardened structure” that integrates security, survival, and functional components. The primary residence, also referred to as indoor dwelling space, connects to various elements essential for safety, survival, and comfort. These elements/components are as follows: security network with a camera system—A security network for visual surveillance to enhance property security. The security network network may also have one or more safe Gun/Ammo/Safe Rooms-Secure rooms for storing firearms, ammunition, and valuables. Property lighting-External lighting to improve visibility and security around the property. A defense station in the attic-A defensive setup is located in the attic to monitor and protect the entire property. The security network may have one or more nuclear containment unit/s and/or anti-radiation suits. Nuclear Containment Room with Anti-Radiation Suits, etc. —A space for managing nuclear threats, equipped with radiation protection gear.

A resource management network may have one or more bug-out bags, which may have a pack of emergency supplies that may help survive independently for up to one and/or two years in the event of an emergency event. Bug Out Bags-Pre-packed emergency kits for quick evacuation or survival needs. A well with hand pump-A manual water source for reliable access to fresh water. Root cellar/canning room-Food storage and preservation space, particularly for root vegetables and canned foods. Indoor and outdoor high-quality and durable cooking equipment and cooking space for long-term and durable use. Medical Room with Antibiotics, Trauma Care, Wound Care, etc. —A room equipped for addressing medical emergencies and providing care. This FIG. emphasizes a well-fortified residence as an example of a self-sustainable turn-key dwelling system designed for resilience against emergencies, combining security, survival resources, and functionality. It integrates both modern systems (like cameras) and traditional methods (like a root cellar and well). This layout may be used for above- and/or below-ground dwelling spaces.

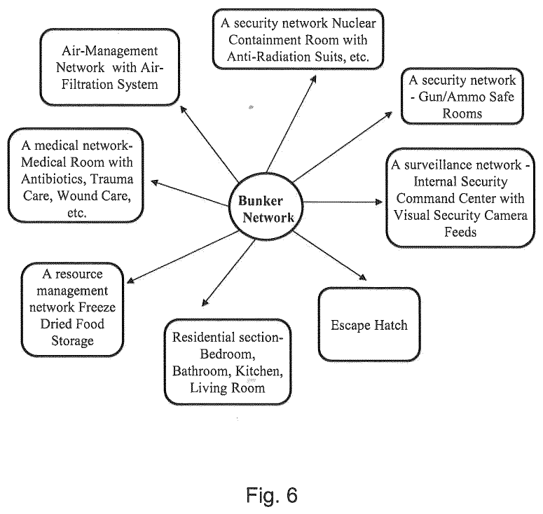

FIG. 6. This is a flowchart representing an underground “Bunker Network” layout with elements or components of the network. The “Bunker Network” has features for various specialized rooms or systems, each serving a unique purpose for survival or security. The features or components are as follows:

Air-Management Network with an air filtration system-Provides air filtration for protection against nuclear, biological, nuclear, chemical, etc. threats and maybe an NBC Swiss Made. A security network with a nuclear containment room with anti-radiation Suits, etc. —A room designed to contain nuclear threats and store anti-radiation suits and related equipment. The security network may also have one or more safe Gun/Ammo/Safe Rooms and/or storage spaces for storing firearms, ammunition, weapons, and valuables. Escape Hatch—An emergency exit mechanism to leave the bunker system and may have an air-sealable door. A surveillance network, including an internal security command center with visual security camera feeds, is a centralized room for monitoring security cameras and managing internal security. A residential section providing a living and dwelling space with bedroom, bathroom, kitchen, living and dwelling room- and other basic living and dwelling amenities. A resource management network with water and food storage is, for example, freeze-dried food and/or canned food, areas for long-term, freeze-dried food supplies. A medical network with a medical room with antibiotics, trauma care, wound care, etc. —A room equipped for medical emergencies and treatments. This layout is for a self-sustainable dwelling designed for long-term survival, safety, and self-sufficiency, particularly in scenarios involving catastrophic events such as but not limited to nuclear or security threats. Although the figure shows an underground bunker network, the same features may be used for above-ground indoor space.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. A self-sustainable turn-key dwelling system comprising a security network, a transportation network, a medical network, an energy management network, an automation network, a waste management network, a tooling work-shop network, an air management network, a surveillance network, a resource management network, outer-self-sustainable dwelling system structures, and indoor-self-sustainable dwelling system structures,
wherein the indoor-self-sustainable dwelling system structures further comprise an above ground indoor-self-sustainable dwelling system structures and underground bunker network, where the above ground indoor-self-sustainable dwelling system structures is integrated with an underground bunker network, and
wherein the dwelling system is configured for up to one year of independent dwelling during disasters.

2. The system of claim 1, wherein the surveillance network comprises at least one drone and at least one outdoor camera.

3. The system of claim 1, wherein the transport network comprising vehicles and fuel required to transport individuals to and from another secure location, wherein the vehicles are bulletproof.

4. The system of claim 1, wherein the resource management network comprises a rain catcher framework, wherein the rain catcher framework is interconnected/interlinked to gutters and configured to catch rain into a water storage unit, wherein the water storage unit with a capacity of up to 1000 gallons.

5. The system of claim 1, wherein the resource management network comprises a food supply infrastructure, wherein the food supply infrastructure comprises long-term a food storage unit and a food renewal modules, the food supply infrastructure, comprising long-term food storage and food renewal modules, and wherein the food supply infrastructure comprises at least one food-storage unit adapted to store food for up to 50 years and at least one food renewal module configured to grow food on the dwelling system.

6. The system of claim 1, wherein the air management network comprising air seals, air suction ventilators, and air filters, wherein the air seals are adapted to seal indoor dwelling from outdoor dwelling air up to 99%, and wherein the air suction ventilators are connected to air filters, wherein the air filters are selected from a group consisting of biological filters,
chemical filters, nuclear filters, and any combination thereof.

7. The system of claim 1, wherein the energy management network comprises an energy-generating subnetwork, wherein the energy-generating subnetwork is installed within 18 inches (457 mm) of the indoor-self-sustainable dwelling system structures.

8. The system of claim 1, wherein the security network comprises at least one nuclear containment unit, wherein the containment unit is indoor and air-tight/sealed.

9. The system of claim 1, wherein the security network comprises an indoor dwelling bunker-network structure integrated with residential-style building structures and at least one outdoor outpost and/or tower, wherein the bunker network is reinforced with concrete and steel, wherein the bunker-network is at least three feet below ground surface.

10. The system of claim 1, wherein the security network comprising an electronic equipment security subnetwork configured to block electromagnetic pulse/radiation from entering indoor dwelling space, and wherein the block is configured via one or more selected from a group consisting of Faraday cage, EMI Shielding (Electromagnetic Interference Shielding), Mu-Metal Shielding, Conductive Enclosures, Shielded Rooms, RF Shielding, Gasket Seals, and any combination thereof.

11. The system of claim 1, wherein the security network comprising of armored-resistant and armored-proof materials selected from one or more from a group consisting of fiberglass, synthetic fiber, Kevlar, Dyneme, ultra-high-molecular-weight polyethylene (UHMWPE), Ceramic, alumina and silicon carbide, Steel, Carbon Nanotubes, Titanium, Aluminum Oxide, Polycarbonate, Composite Armor, a combination of ceramics, metals, and fibers, Graphene, and any combination thereof.

12. The system of claim 1, wherein the security network comprises window-coverings and door-coverings, wherein the coverings have at least three Gear Consoles and shelves with gun holders configured to organize the coverings.

13. The system of claim 1, wherein the security network comprising roof overhangs and window drip edge configured to protect the indoor-self-sustainable dwelling system structures from rainwater, and wherein the roof overhangs and window drip are connected to rain catchers.

14. The system of claim 1, wherein the security network and energy management network comprises a closed-cell foam-insulated ceiling, acoustic foam-covered walls, and a high-density foam pad underneath a marine-carpeted floor configured to provide insulation and sound security.

15. The system of claim 1, wherein the security network comprises windows and doors having high-quality automotive window gaskets and door molding adapted to seal the window and doors.

16. The system of claim 1, wherein the indoor-self-sustainable dwelling system structures are up to 5,000 square feet, and wherein the outer-self-sustainable dwelling system structures are up to 10,000 square feet, wherein the indoor-self-sustainable dwelling system structures have up to 10 inches structural channel reinforcements, wherein the indoor-self-sustainable dwelling system structures are surrounded by a steel wall up to 0.5 inches thick, and
wherein the indoor-self-sustainable dwelling system structures have up to 15-inch reinforced concrete walls.

17. The system of claim 1, wherein the outer-self-sustainable dwelling system structures comprise dynamic camouflage structures, wherein the dynamic camouflage structures incorporate photochromic and electrochromic coatings that adjust color, reflectivity, and thermal signature to blend into surrounding environments.

18. A modular, AI-enhanced disaster-resistant dwelling system comprising:
a biometrically adaptive access control system, motorized, robotic partitions and furniture system, a high-resilience underground bunker network, nuclear, biological, and chemical (NBC) air filtration systems, an AI-guided transportation network, a drone-based cargo and supply delivery system, capable of autonomously restocking food, medical supplies, and energy reserves,
wherein the biometrically adaptive access control system utilizing multi-factor authentication and configured to analyze to regulate entry permissions to designated zones, a reconfigurable smart interior,
wherein the motorized partition and furniture system is adapted to occupant needs for emergency lockdown, expanded communal spaces, or isolated medical zones,
wherein underground bunker network incorporates blast-resistant reinforced concrete and carbon-nanotube-reinforced steel alloys for impact protection, and
wherein the AI guided transportation comprises at least one armored bug-out vehicle with integrated fuel storage, remote AI navigation, and autonomous security measures is deployed for emergency evacuation or resupply missions network.

19. A self-sustaining dwelling system, comprising:
an artificial intelligence (AI)-powered resource management system, an integrated underground bunker, a self-healing structural material layer, an autonomous drone-based surveillance system, and EMP-shielded infrastructure utilizing a multi-layered Faraday-cage, and blockchain-encrypted cybersecurity system;
wherein the AI-powered resource management system is configured to autonomously optimize energy consumption, water usage, waste processing, and climate control in real time based on occupant activity and environmental conditions,
wherein the integrated underground bunker is equipped with an AI-calibrated climate control system to maintain optimal living conditions,
wherein the self-healing structural material layer utilizes biopolymer-infused concrete or nanocomposite materials to repair cracks and fractures automatically,
wherein the dwelling structure comprises biopolymer-infused concrete or nanocomposite materials capable of autonomously repairing cracks, fractures, or environmental damage,
wherein the autonomous drone-based surveillance system is configured to utilize facial recognition, LiDAR scanning, and AI-driven threat detection,
wherein the EMP-shielded infrastructure utilizing a multi-layered Faraday-cage enclosure to protect electronic components from electromagnetic interference or attacks, and
wherein the blockchain-encrypted cybersecurity system secures all digital communication and access controls within the dwelling.

20. The self-sustaining dwelling system of claim 19, further comprising a dynamic camouflage system, a security network, a renewable energy harvesting network, energy-storing concrete infrastructure, a kinetic energy harvesting flooring system, a sustainable water generation and purification system, AI-controlled water recycling and distribution network, and an AI-managed waste conversion system;
wherein the dynamic camouflage system comprises the outer walls of the dwelling structure with photochromic and electrochromic coatings configured to adjust color, reflectivity, and thermal signature to blend into surrounding environments,
wherein the security network comprises an autonomous robotic perimeter surveillance unit configured to deploy kinetic response barriers and non-lethal deterrent measures in response to unauthorized intrusions,
wherein the renewable energy harvesting network comprises a quantum-dot photovoltaic panel array configured to convert solar energy with high efficiency,
wherein the energy-storing concrete infrastructure comprises thermal batteries store and release energy incorporated into walls and floors,
wherein the kinetic energy harvesting flooring system comprises piezoelectric materials configured to generate electrical power from occupant movement,
wherein the sustainable water generation and purification system comprises the atmospheric water harvesting technology utilizing graphene-based filtration membranes to extract and purify moisture from ambient air,
wherein the AI-controlled water recycling and distribution network dynamically adjusts water supply for sanitation, irrigation, and drinking purposes, and
wherein the AI-managed waste conversion system comprises organic waste is processed using a microbial bioreactor to produce renewable biofuel and soil-enriching compost for on-premises agriculture.
